(19) United States
(12) Patent Application Publication
(10) Pub. No.: US 2005/0186861 A1
(43) Pub. Date: Aug. 25, 2005

(54) Exterior shear shoulder assembly for outboard motors and outdrives

(76) Inventor: Charles S. Powers, Shreveport, LA (US)

Correspondence Address: John M. Harrison, 2139 E. Bert Kouns, Shreveport, LA, 71105, US

(21) Appl. No.: 11/059,425

(22) Filed: Feb. 16, 2005

Related U.S. Application Data
(60) Provisional application No. 60/545,994, filed on Feb. 20, 2004.

(51) Int. Cl. B63H 1/14; B63H 23/34; F16D 3/14; F16D 47/02; F16D 69/00

(52) U.S. Cl. 440/49; 440/83

(57) ABSTRACT

An exterior progressive shear shoulder assembly which is adapted for connecting a marine propeller to a propeller drive shaft in such a manner that a selected torsional resistance of the propeller with respect to the drive shaft is achieved. In one embodiment a driver engaging the propeller drive shaft also receives a driver adaptor that fits inside the propeller hub and drivingly engages the propeller through interfacing torsion members such as torsion ribs and/or selected sets of shear rods, each having a selected length, composition and resilience. In another embodiment the drive shaft directly engages the driver adaptor. In the event that the rotating propeller inadvertently strikes or is entangled in an underwater object, the fixed or replaceable torsion ribs and/or shear rods deform and may shear between the propeller hub and driver adaptor to allow rotation of the driver adaptor in the propeller hub and absorb the torque shock. The torque load deformation and shearing actions are optimized in a preferred embodiment by the provision of air gaps defined on each side of the torsion members between the driver adaptor and a driver adaptor hub fixed inside the propeller hub and by resilient sheaths provided on the torsion members.

### CROSS-REFERENCE TO RELATED APPLICATIONS

This application claims the benefit of and incorporates by reference prior filed copending U.S. Provisional Application Ser. No. 60/545,994, Filed Feb. 20, 2004.

### SUMMARY OF THE INVENTION

An exterior shear shoulder assembly typically including fixed or removable shearable torsion members such as torsion ribs and/or multiple, solid, spring embedded or gas-filled shear rods or cylinders of similar or variable resilience, number, composition and length for absorbing propeller torque overloads. These elements are interposed in selected combinations between the propeller hub of a marine propeller and a propeller drive shaft typically using a tapered driver adaptor fitted in a driver adaptor hub fixed to the propeller hub and either directly receiving the drive shaft or receiving a driver fitted on the drive shaft. This design ensures that a desired balance of resilience and torsional resistance of the propeller hub with respect to the drive shaft is achieved for different torque applications of the propeller. Typically, one or more adaptor recesses of selected size and depth and companion resilient rib sheaths or rod cushions are provided in a cylindrical driver adaptor for receiving one or more, typically replaceable, torsion ribs and/or shear rods, respectively. A driver typically engages both the drive shaft of an outboard motor or outdrive and a tapered driver adaptor in the propeller hub. The rib sheath-encased torsion rib(s) and/or the cushioned shear rod(s) extend from the driver adaptor in radially spaced-apart relationship with respect to each other, also engaging corresponding torsion rib seats typically shaped in a driver adaptor hub fixed inside in the propeller hub or in the propeller hub itself. The driver adaptor and driver adaptor hub serve to interface the driver and the propeller at the deformable and shearable torsion ribs and/or the shear rods. The torsion ribs may be removable or typically cast or shaped with the driver adaptor of a suitable metal such as brass, aluminum, zinc or the like, whereas the rods or cylinders can all be constructed of the same composition and resilience, or any combination and sequence of rods or cylinders having different compositions and resilience can be used to achieve a selected balance of torsional resistance and resilience of the propeller with respect to the drive shaft during high torque loads. Alternatively, the torsion rods can be removably seated in the driver adaptor, as hereinafter described. The applicable torque loads are frequently due to power surges and may also be applied in the event that the propeller strikes or is entangled in a submerged object and suddenly slows or stops its rotation. In such an event, the torsion ribs and/or the shear rods or cylinders are subjected to the engine drive train torque load and in the case of the shear rods or cylinders or the removable resilient torsion ribs, one or more of the rods and/or cylinders or torsion ribs are compressed, either against the opposite sides of the torsion rib seats in the driver adaptor hub or into optional air gaps defined by corresponding air gap planes shaped in the driver adaptor hub and the adjacent curvature of the cylindrical driver adaptor outside surface. In the case of the rib sheath-encased, typically shearable metal torsion ribs, the torsion ribs are forced against the resilient sheath shoulders to absorb the torque load. If the torque load continues to be applied, one or more of these torsion ribs and/or cylinders or rod elements or members are sheared, typically at the top parallel edges of the corresponding adaptor recesses, if replaceable torsion elements are used, as the torque shock imparted by the still-rotating drive shaft is absorbed by the torsion members. Accordingly, the shear rods and/or cylinders, as well as the removable resilient torsion ribs and the rib sheaths, tend to first deform and then shear as the driver adaptor rotates inside the driver adaptor hub, to prevent or minimize damage to the propeller and/or the drive shaft, gears and the propeller driver train components, and in some designs, can typically be easily and inexpensively replaced. The typically metal torsion ribs that receive the respective sheath shoulders will first rupture the sheath shoulders and then shear or partially shear, as they engage the respective air gap planes in the driver adaptor hub. Some of the shear rods and/or fixed torsion ribs and the removable torsion ribs typically remain sufficiently intact and have sufficient structural integrity to facilitate continued drive capability between the motor drive shaft and the propeller at lower torque applications, for continued operation of the watercraft at slower speeds.

### BRIEF DESCRIPTION OF THE DRAWINGS

The invention will be better understood by reference to the accompanying drawings, wherein:

FIG. 1 is an exploded, perspective view of a first embodiment of the exterior shear shoulder assembly of this invention;

FIG. 2 is a sectional view of the exterior shear shoulder assembly illustrated in FIG. 1, taken along line 2-2, more particularly illustrating the interfacing driver, driver adaptor and driver adaptor hub with air gaps and rib sheaths;

FIG. 2A is a sectional view of an alternative embodiment of the exterior shear shoulder assembly illustrated in FIG. 1, wherein the motor drive shaft directly engages the driver adaptor, thus eliminating the driver illustrated in FIGS. 1 and 2;

FIG. 3 is an exploded, perspective view of another embodiment of the exterior shoulder assembly of this invention, more particularly illustrating the driver, driver adaptor and driver adaptor hub elements illustrated in FIG. 2;

FIG. 4 is a perspective, partially exploded view of the driver adaptor with removable, recessed, wide torsion ribs fitted with rib sheaths illustrated in FIG. 3;

FIG. 5 is a sectional view of the exterior shear shoulder assembly driver adaptor and driver adaptor hub with air gaps and rib sheaths illustrated in FIGS. 3 and 4;

FIG. 6 is a perspective, partially exploded view of another embodiment of an alternative driver adaptor fitted with removable shear rods seated on optional resilient rod cushions provided in the exterior shear shoulder assembly of this invention;

FIG. 7 is a transverse sectional view of a driver adaptor hub with air gaps and rod cushions receiving the driver adaptor illustrated in FIG. 6;

FIG. 8 is a perspective, partially exploded view of still another driver adaptor with removable, rib sheath-covered and recessed, tapered torsion ribs, for use in the exterior shear shoulder assembly of this invention;

FIG. 9 is a transverse sectional view of a driver adaptor hub without air gaps, receiving the driver adaptor illustrated in FIG. 8;

FIG. 10 is a perspective, partially exploded view of still another driver adaptor having recessed, narrow torsion ribs fitted with resilient rib sheaths;

FIG. 11 is a transverse sectional view of a driver adaptor hub with air gaps, receiving the driver adaptor illustrated in FIG. 10;

FIG. 12 is a sectional view of yet another configuration of the driver adaptor, having integral, non-removable, typically shearable metal and rib sheath-covered torsion ribs and seated in a driver adaptor hub having air gaps; and

FIG. 13 is a transverse section view of another configuration of the driver adaptor with a single, integral, metal non-removable torsion ribs having resilient rib sheaths and seated in a driver adaptor hub having air gaps.

### DESCRIPTION OF THE PREFERRED EMBODIMENTS

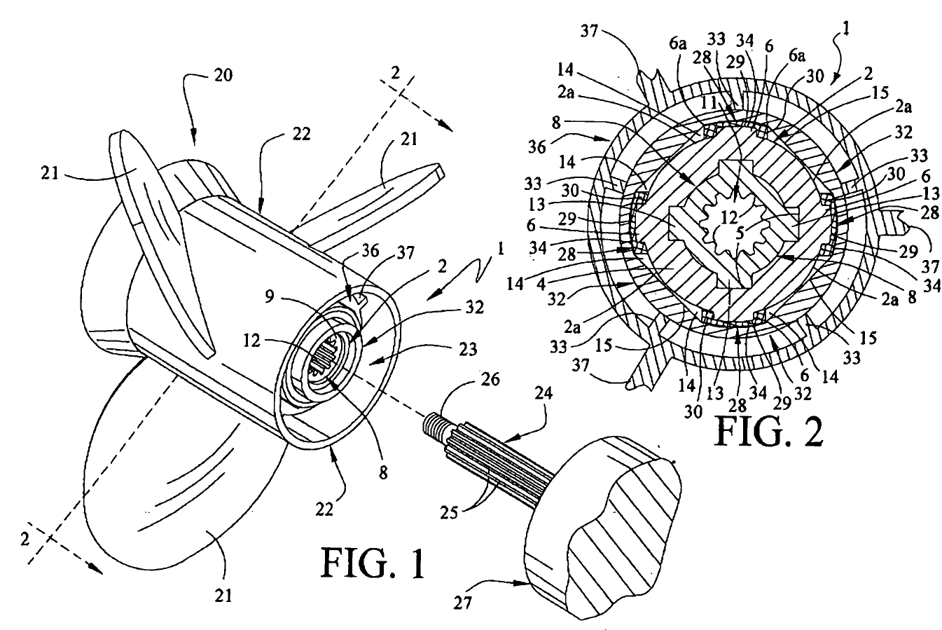

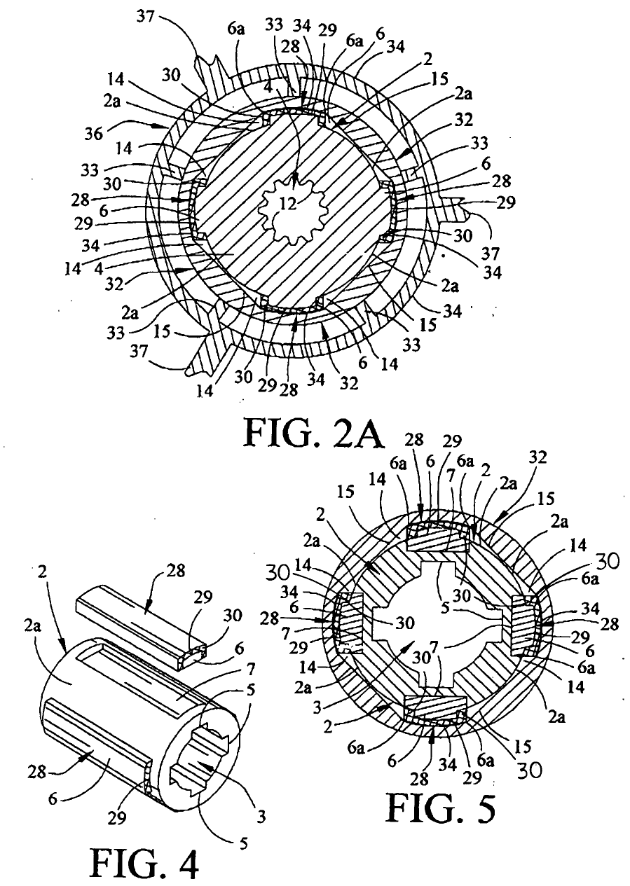

Referring initially to FIGS. 1 and 2 of the drawings, a first embodiment of the exterior shear shoulder assembly of this invention is generally illustrated by reference numeral 1. As illustrated in FIG. 1, the exterior shear shoulder assembly 1 is suitably adapted for coupling a propeller drive shaft 24, provided with drive shaft splines 25 and connected to an outboard motor or outdrive gear housing 27, to a marine propeller 20, having propeller blades 21 extending from a propeller hub 22. The exterior shear shoulder assembly 1 is designed to provide a selected torsional load resistance between the propeller drive shaft 24 and the propeller hub 22, by imparting a selected resilience and progressive deformation and shear capability between those components. This design prevents or minimizes damage to the propeller drive train and drive system during power surges and accidental torque loads in the event that one or more of the propeller blades 21 of the rotating propeller 20 inadvertently strikes or becomes entangled in a submerged object (not illustrated) while the drive shaft 24 is still rotating. The exterior shear shoulder assembly 1 illustrated in FIG. 1 typically includes a cylindrical, typically tapered driver adaptor hub 32, fixed or shaped inside a like-shaped adaptor hub case 36, typically by means of radially-oriented adaptor hub mount bars 33 (FIG. 2). The adaptor hub case 36 is also typically mounted in the propeller hub interior 23 of the propeller hub 22 by means of the radial case bars 37, as illustrated in FIG. 2. Alternatively, the driver adaptor hub 32 can be configured or fixed directly inside the propeller hub 22, as desired. A typically correspondingly-tapered driver adaptor 2 is fitted inside the driver adaptor hub 32 and has a rounded or cylindrical outside adaptor surface or side 2a, interrupted by four integral torsion ribs 6 of selected size, material and resilience, that extend from the driver adaptor 2 in spaced-apart relationship with respect to each other into corresponding rounded torsion rib seats 34, provided in the driver adaptor hub 32 (FIG. 2). A rib sheath 28 includes a resilient sheath cap 29 disposed between the ends of the torsion ribs 6 and the corresponding torsion rib seats 34, and sheath shoulders 30, extending from both ends of the sheath cap 29 into the respective air gaps 14. Air gap planes 15 typically extend between the respective torsion rib seats 34 in the driver adaptor hub 32 to define one dimension of the air gaps 14. The torsion ribs 6 each have a rib shoulder 6a, covered by a rib sheath 28, extending inwardly from the torsion rib seats 34 and the air gap planes 15, to further define the air gaps 14, which are located between the respective areas of the curved adaptor side 2a and the corresponding air gap planes 15, that are typically tangent to the respective adaptor side 2a arcs.

Accordingly, referring again to FIGS. 1 and 2 of the drawings in a first preferred embodiment of the invention the driver adaptor 2 fits inside the driver adaptor hub 32, which is, in turn, fixed in the propeller hub interior 23 of the propeller hub 22, typically by means of the adaptor hub mount bars 33, as well as the adaptor hub case 36 and the case bars 37. In addition, a driver 8 is configured to fit inside and engage the driver adaptor 2 by means of multiple driver ribs 13 that seat in corresponding driver rib seats 5 provided in the bore of the driver adaptor 2, as illustrated in FIG. 2.

Referring to FIG. 2A of the drawings, in an alternative drive configuration, a driver adaptor bore 4 is provided in the longitudinal center of the driver adaptor 2 and the propeller drive shaft 24, illustrated in FIG. 1 may be seated therein, with the internal driver splines 12 of the driver adaptor 2 engaging the corresponding drive shaft splines 25. This arrangement eliminates use of the driver 8 to drive the driver adaptor 2 and the propeller 20.

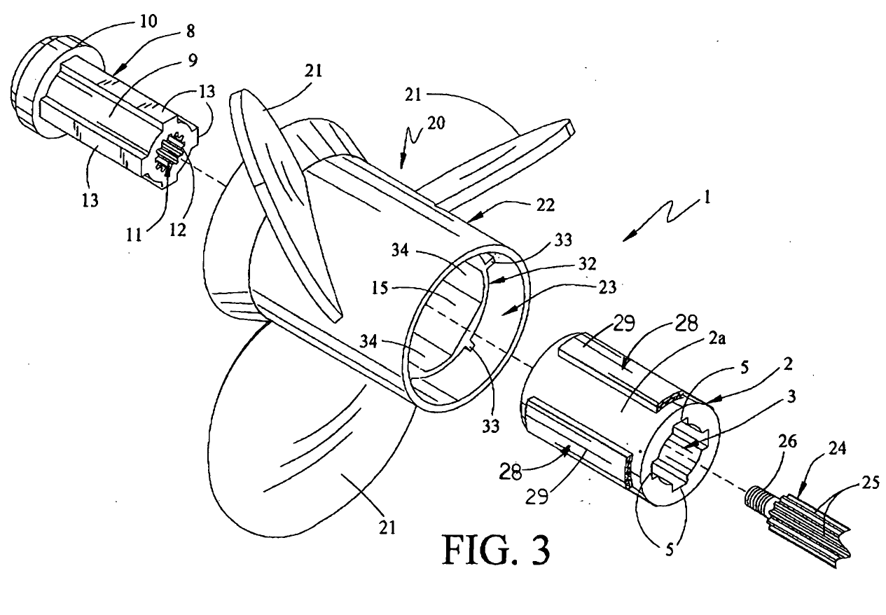

Referring now to FIGS. 3-5 of the drawings, in another preferred embodiment of the invention the driver adaptor hub 32 is typically fixed or shaped inside the propeller hub interior 23 of the propeller hub 22 using the multiple adaptor hub mount bars 33, as illustrated in FIG. 3. The interior of the driver adaptor hub 32 is preferably slightly tapered and provided with air gap planes 15, spaced by the curved torsion rib seats 34, for receiving the correspondingly tapered, typically removable, driver adaptor 2 and matching the removable, radially spaced-apart torsion ribs 6, encased in the rib sheaths 28, in the respective adaptor recesses 7 with the corresponding radial torsion rib seats 34, as illustrated in FIG. 5. As in the FIG. 2 and 2A embodiments, air gaps 14 are defined between the respective curved adaptor side 2a segments and the corresponding air gap planes 15, for purposes which will be further hereinafter described. In a preferred aspect of this embodiment of the invention the torsion ribs 6 are large at the tip, replaceable and are glued or otherwise bonded and seated in the corresponding adaptor recesses 7 provided in the cylindrical adaptor side 2a of the driver adaptor 2, as further illustrated in FIG. 4 of the drawings. Accordingly, torsion ribs 6 of selected thickness and composition can be fitted, clad or coated with the resilient rib sheaths 28 and replaced as desired, in the same driver adaptor 2 to facilitate a more flexible installation of the exterior shear shoulder assembly 1. As in the case of the exterior shear shoulder assembly 1 illustrated in FIGS. 1 and 2 of the drawings, the driver 8 used to drive the driver adaptor 2 illustrated in FIGS. 4 and 5 is fitted with driver ribs 13, spaced-apart on a driver shaft 9, one end of which driver shaft 9 terminates at an enlarged driver base 10, as illustrated in FIG. 3. A driver bore 11 extends longitudinally through the interior of the driver shaft 9 and is fitted with internal driver splines 12, as further illustrated in FIG. 3. Referring again to FIG. 3, the driver adaptor 2 is characterized by a longitudinal driver adaptor interior 3 having recessed internal driver rib seats 5 that accommodate the corresponding driver ribs 13 on the driver shaft 9 of the driver 8 and facilitate concurrent rotation of the driver adaptor 2 and the propeller 20 responsive to torque applied to the driver 8. The driver 8 is, in turn, driven by rotation of the propeller drive shaft 24, fitted with external drive shaft splines 25 that mesh with the corresponding internal driver splines 12 provided in the driver bore 11 of the drive shaft 9. The propeller drive shaft 24 is also fitted with a threaded shaft nipple 26 for receiving a nut (not illustrated) to secure the propeller 20 in place on the propeller drive shaft 24 in conventional fashion.

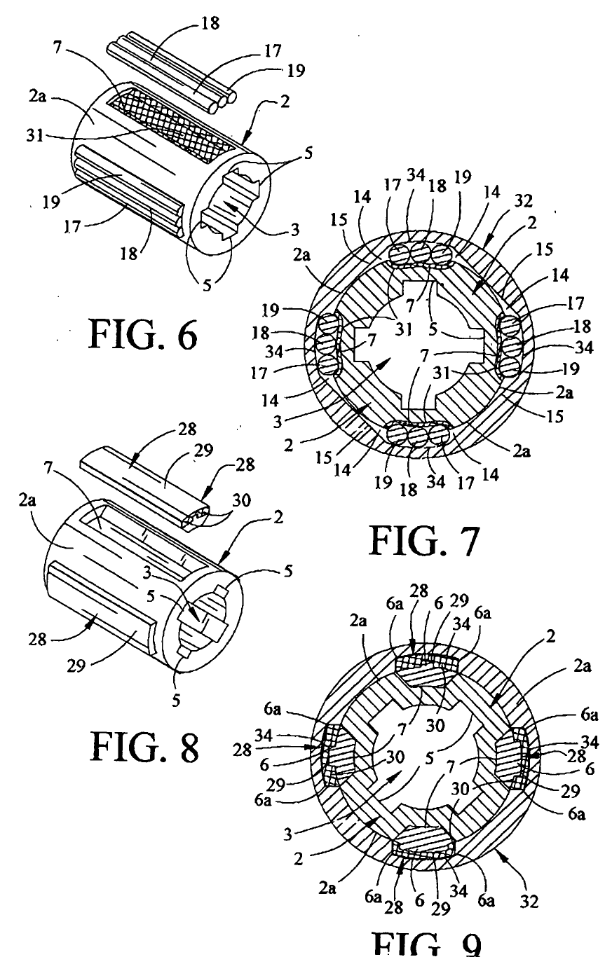

Referring now to FIGS. 6 and 7 of the drawings, another embodiment of the exterior shear shoulder assembly 1 includes a driver adaptor 2 having spaced-apart adaptor recesses 7 of selected size and depth, radially provided in a generally cylindrical adaptor side 2a, and each coated, clad or fitted with a resilient rod cushion 31. The adaptor recesses 7 each receive a typical group or set of plastic shear rods or cylinders 17, rubber shear rods 18, and/or metal shear rods or cylinders 19 (FIG. 6). The metal shear rods or cylinders 19 are of selected diameter, type composition and density, having an empty or gas-filled cavity and characterized by selected resilience and strength and are seated on the rod cushion 31 in each adaptor recess 7 in selected combinations and sequences. A driver 8 is designed as illustrated in FIG. 3, with a circular adaptor base 10, from which extends the elongated adaptor shaft 9, fitted with multiple, longitudinal, external, adjacent driver ribs 13, and is designed for insertion in the driver adaptor interior 3 of the driver adaptor 2, to drive the driver adaptor 2 in the same manner as illustrated in FIG. 3 of the drawings. It will be appreciated by those skilled in the art that the resilient rod cushions 31 may be omitted from the respective adaptor recesses 7 in the driver adaptor 2, under circumstances where only the rubber shear rods 18 are used therein, since a primary function of the resilient, flexible rod cushions 31 is to compensate for irregularities in the casting and fit of the driver adaptor 2 and the driver adaptor hub 32.

In the embodiment illustrated in FIGS. 6 and 7, one or more rubber shear rod 18 may be interposed between a pair of plastic shear rods 17 in each adaptor recess 7 without the use of a metal shear rod or cylinder 19 (FIG. 6) to achieve a torsional resistance and resilience which is a function of the combined resilience of the plastic shear rods 17 and the rubber shear rods 18. It is understood that three of the plastic shear rods 17, three of the rubber shear rods 18 or three of the metal shear rods 19, or any combination of the plastic shear rods 17, rubber shear rods 18 and metal shear rods 19, can be seated in any or all of the adaptor recesses 7, depending upon the desired resilience and torsional resistance characteristics of the propeller 20 with respect to the propeller drive shaft 24. For example, in applications where a constant or variable, considerably high torque load is applied to the exterior shear shoulder assembly 1, such as in start-up loads in high-speed boat racing, three plastic shear rods 17 may typically be provided in each adaptor recess 7. For lower torque load applications, the plastic shear rods 17 can be used in combination and in selected sequences with the rubber shear rods 18, typically such that a rubber shear rod 18 is interposed between a flanking pair of plastic shear rods 17, as illustrated in one of the adaptor recesses 7 (FIG. 6). Alternatively, the plastic shear rods 17 are positioned adjacent to each other with a rubber shear rod 18 located adjacent to one of the plastic shear rods or cylinders 17. Under circumstances in which the exterior shear shoulder assembly 1 undergoes minimal torque loading applications, a typical set of three rubber shear rods 18 or one or a pair of rubber shear rods 18, alone or in combination with a plastic shear rod 17 in any selected sequence, can be seated in each adaptor recess 7. Finally, when little or no shearing is desired in the event that one or more of the propeller blades 21 strikes or becomes entangled in an underwater object, the metal shear rods 19, typically constructed of a shearable metal such as brass, zinc and/or aluminum, may be seated in each adaptor recess 7, as illustrated in FIG. 6. Other devices for varying the degree of resiliency and shear of these elements may include the addition of coil springs and the like, embedded in one or more of the rods or cylinders, and gas-filled rods or cylinders, in non-exclusive particular.

Referring now to FIGS. 8 and 9 of the drawings in another embodiment of the invention the driver adaptor 2 is characterized by at least one, and preferably four, wedge-shaped adaptor recesses 7, each of which accommodates a correspondingly-shaped, resilient or shearable metal torsion rib 6, in the latter case, typically fitted with a resilient rib sheath 28. As in the case of the embodiments heretofore described with regard to FIGS. 4-7 of the drawings, a shaped driver adaptor interior 3 is provided in the driver adaptor 2 for receiving a corresponding driver 8, as illustrated in FIG. 3, for the driving purposes heretofore described. The driver adaptor 2 is preferably tapered for fitting inside a correspondingly tapered and typically removable driver adaptor hub 32, shaped generally in the same configuration as the driver adaptor hub 32 illustrated in FIGS. 3-7 of the drawings. Referring to FIG. 9, it will be appreciated that the torsion ribs 6 are narrow at the tip and are typically shaped for seating more deeply in the wedge-shaped corresponding adaptor recesses 7, than they are in the corresponding adaptor recesses 7 illustrated in FIG. 5, thus presenting less resistance at the tip to a torquing load applied to the driver adaptor 2 by the driver 8, as heretofore described. Further, in contrast to the driver adaptor 2 and driver adaptor hub 32 combination illustrated in FIG. 5, no air gap is defined between the adaptor side 2a segments or areas of the driver adaptor 2 and the interior wall of the driver adaptor hub 32 at the air gap planes 15. Accordingly, under circumstances where the respective torsion ribs 6 illustrated in FIGS. 8 and 9 are constructed of the same or similar material and therefore have the same or similar resilience and resistance to torque load as the torsion ribs 6 illustrated in FIG. 5, then less torque load would be required to deform the sheath shoulders 30 of the rib sheaths 28 and shear the smaller torsion ribs 6 illustrated in FIG. 9, than would be the case in the torsion ribs 6 illustrated in FIG. 5.

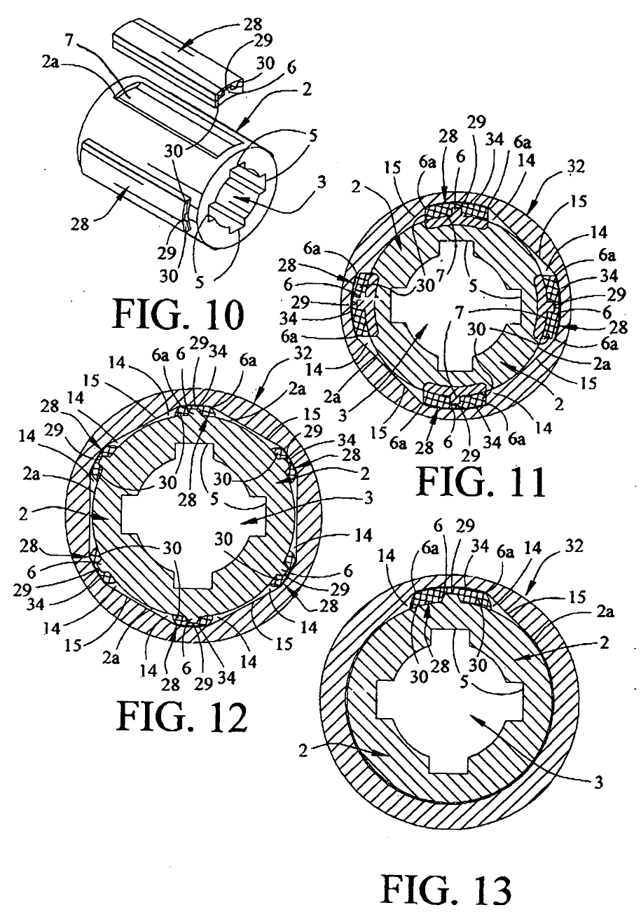

Referring now to FIGS. 10 and 11 of the drawings in another embodiment of the invention the driver adaptor 2 is again characterized by a smooth, cylindrical adaptor side 2a, fitted with thin, resilient or shearable metal torsion ribs 6 that have corresponding rib sheaths 28 and a bottom curvature, and are arranged in spaced-apart relationship and are secured by glue or otherwise bonded in an adaptor recess 7 in the adaptor side 2a by any convenience means, such as gluing, in non-exclusive particular. As in the case of the driver adaptors previously described, the driver adaptor 2 illustrated in FIGS. 10 and 11 is typically tapered for easy ingress and egress and is characterized by a driver adaptor interior 3 for receiving the driver 8 illustrated in FIG. 3, to facilitate application of a torque load on the driver adaptor 2 in the manner heretofore described. It will be appreciated from a consideration of the driver adaptor 2 illustrated in FIGS. 10 and 11 that considerably less torque would be required to effect distortion of the sheath shoulders 30 of the rib sheaths 28 and failure of the respective slightly recessed torsion ribs 6 or any of them, when the driver adaptor 2 is subjected to a torquing load by application of the driver 8, than would be possible in previous driver adaptor 2 designs. Accordingly, the degree of distortion of the respective sheath shoulders 30 and shearing or partial shearing of the torsion ribs 6 is a function of the thickness and composition of the sheath shoulders 30, as well as the length, thickness and material of construction of the torsion ribs 6 and the strength of the glue or other bonding means used to secure the respective torsion ribs 6 to the adaptor side 2a of the driver adaptor 2. As in the case of previous designs of the exterior shear shoulder assembly 1, the driver adaptor hub 32 is typically constructed in the same manner as previous discussed designs in FIGS. 5 and 7. This design includes the air gap planes 15, such that an air gap 14 is defined adjacent to the adaptor side 2a and both sides of the respective rib shoulders 6a of the torsion ribs 6, to accommodate the sheath shoulders 30 and facilitate projection of at least a portion of the respective deformed torsion ribs 6 into the corresponding air gap 14 by torque load and optimize the attenuation of the torque load applied to the driver adaptor 2, in the event of interruption or rapid slowing of rotation of the propeller 20 illustrated in FIGS. 1 and 3 of the drawings.

Referring now to FIG. 12 of the drawings in still another embodiment of the invention, the driver adaptor 2 in the exterior shear shoulder assembly 1 is characterized by multiple torsion ribs 6 of selected size that are integrally shaped in the body of the driver adaptor 2 and include the rib sheaths 28, as they project into corresponding curved torsion ribs seats 34, shaped in the driver adaptor hub 32. Accordingly, the torsion ribs 6 are characterized by additional strength, not only in terms of shear resistance, but also due to the larger number of rib sheath 28-clad torsion ribs 6 provided in the driver adaptor 2. This facility allows a much greater non-shearing torque to be applied to the driver adaptor 2 by operation of the driver 8 illustrated in FIG. 3, for example, under circumstances where the propeller 20 strikes an underwater obstacle or is otherwise caused to rapidly slow down or stop in its rotation, as heretofore described. The driver adaptor 2 design illustrated in FIG. 12 is therefore typically applicable to a marine drive system wherein both expected and unforeseen high torque loads are applied to the driver adaptor 2 through the driver 8, which extends into the driver adaptor interior 3, as further heretofore described. The driver adaptor hub 32 has, in a preferred embodiment, air gap planes 15 which facilitate multiple air gaps 14 located on each side of the respective torsion ribs 6 at the respective rib shoulders 6a. This facility allows selective deformation of the respective sheath shoulders 30 on each side of the torsion ribs 6 under torque loads applied to the driver 8 (FIG. 3), tending to rotate the driver adaptor 2 in either the clockwise or counterclockwise direction, depending upon whether the propeller is turning in the forward or reverse direction.

As illustrated in FIG. 13 a single torsion rib 6, having a rib sheath 28, is integrally provided in the driver adaptor 2 for selected applications under circumstances where the torque load is such that a single torsion rib 6 with sheath shoulders 30 of selected composition, size and resiliency, will facilitate optimum protection of the propeller 20 where the propeller 20 is interrupted or stopped in its rotation. Accordingly, the driver adaptor hub 32 is characterized by a single torsion rib seat 34 that accommodates the lone rib sheath 28-covered torsion rib 6, and a pair of optional air gaps 14 are defined on either side of the torsion rib 6 at the rib shoulders 6a. Torque loads applied to the driver adaptor 2 through the driver 8 (FIG. 2) responsive to interruption of rotation of the propeller 20, therefore cause the appropriate forward or reverse sheath shoulders 30 on the single torsion rib 6 to deform and ultimately fail, if the load is sufficiently great, to optimize protection of the propeller driver train in this circumstance.

Referring again to FIGS. 1-3 and 9 of the drawings, in typical operation of the exterior shear shoulder assembly 1, as the rotating propeller 20 rapidly speed up, slows or stops and the propeller drive shaft 24 thus applies a torque load on the driver 8, (or directly on the driver adaptor 2, as illustrated in FIG. 2A), the driver adaptor 2 also speed up, slows or stops. Each torsion rib 6 and/or the plastic shear rods or cylinders 17 then applies a corresponding force against the corresponding torsion rib seat 34 in the driver adaptor hub 32. Consequently, the respective affected sheath shoulders 30 on the corresponding torsion rib(s) 6, and/or the plastic shear rods or cylinders 17 and intervening rubber shear rod 18 are progressively compressed, either in each adaptor recess 7 (FIGS. 5-9) or as an integral part of the driver adaptor 2 (FIGS. 2, 2A, 12 and 13), or as glued or otherwise bonded to the adaptor side 2a (FIG. 11), at the rib shoulders 6aand/or the plastic shear rods or cylinders 17. This condition typically results during normal shifting of the gear train (not illustrated) into forward or reverse operation with normal power surges at start-up, or if one or more of the propeller blades 21 strikes or becomes entangled in an underwater obstacle (not illustrated), as heretofore described. Accordingly, this compression and distortion smooths the shifting operation during normal operation and allows shearing of the sheath shoulders 30, the torsion rib(s) 6 and/or the plastic shear rods 17 and rubber shear rods 18 to protect the gears and drive train in the gear housing 27 from damage due to inadvertent high torque loads. The torsion rib(s) 6 and/or the plastic shear rods or cylinders 17 and rubber shear rods 18 are progressively compressed and typically forced at least partially into the corresponding air gaps 14, or, like the metal shear rods 19, they are sheared, as the compressive torque load or loads increase.

Referring again to FIG. 7 of the drawings, the plastic shear rod 17 positioned adjacent to the corresponding impinging wall of the adaptor recess 7 typically shears first, followed by the sandwiched rubber shear rod 18 and finally, the plastic shear rod 17 located adjacent to the corresponding and opposite wall of the adaptor recess 7 of the driver adaptor 2. Any or all of the rubber shear rods 18 and plastic shear rods 17 may or may not shear, depending upon the magnitude of the torque load or shock between the driver adaptor 2 and the motor drive shaft 24 and for example, whether the propeller 20 disengages a submerged obstacle. Typically, one or more of the sheath shoulders 30 on the torsion rib(s) 6 and the rubber shear rods 18 and the remaining plastic shear rod 17 or at least, the remaining plastic shear rod 17 in each set of the various embodiments of the exterior shear shoulder assembly 1 of this invention remains unsheared, to provide continued driving engagement of the propeller drive shaft 24 and the propeller 20 and facilitate sustained rotation and driving operation of the propeller 20 in the water. The sheared or damaged rib sheaths 26 on the torsion rib(s) 6 and/or the plastic shear rods 17 and rubber shear rods 18 can be easily replaced in the embodiments of the invention illustrated in FIGS. 4-9, by first removing the drive shaft 9 of the driver 8 from the driver adaptor interior 3 (FIG. 5) or the propeller drive shaft 24 from the driver adaptor bore 4 (FIG. 2A) and then removing the driver adaptor 2 from the hub interior 23; removing the sheared or damaged rib sheaths 28 and torsion ribs 6 and/or the plastic shear rods 17 and rubber shear rods 18 from each respective adaptor recess 7; positioning replacement rib sheath 28-clad torsion ribs 6 and/or plastic shear rods 17 and rubber shear rods 18 in each corresponding adaptor recess 7; replacing the driver adaptor 2 in the driver adaptor hub 32; and re-inserting the drive shaft 9 of the driver 8 in the driver adaptor interior 3 or the propeller drive shaft 24 in the driver adaptor bore 4, as required.

It will be appreciated by those skilled in the art that the respective embodiments of the exterior shear shoulder assembly 1 of this invention can be constructed using one or more shearable, typically plastic or metal, rib sheath 28-clad torsion ribs 6 and/or shear rods 17, rubber shear rods 18, metal shear rods 19 or wooden torsion ribs 6 or shear rods or cylinders (not illustrated) of any selected resilience, porosity or hardness, cross-sectional configuration and length, to achieve a selected torsional resistance between the propeller drive shaft 24 and the propeller 20. It is understood that the respective torsion ribs and the shear rods or cylinders can be constructed in any desired cross-sectional shape, including polygonal, in non-exclusive particular, and the resilience and torsional resistance can further be modified, as desired, by varying the length and wall-thickness of the rib sheaths, as well as the underlying torsion ribs and the tubular shear rods, with greater lengths increasing both torsional and longitudinal resistance and smaller lengths decreasing the torsional and longitudinal resistance. The rib sheaths 28 and rod cushions 31 serve not only to impart the desired resiliency in the assembly, but also to facilitate a better fit between the driver adaptor 2 and the driver adaptor hub 32, considering the variations in the size of these components due to the casting process.

Referring again to FIGS. 3-9 of the drawings, it will be further appreciated by those skilled in the art that any desired number, shape and depth of the adaptor recesses 7 can be provided in the cylindrical adaptor side 2a of the driver adaptor 2, and further, any desired number of the torsion ribs, shear rods or cylinders of selected resilience and composition can be positioned in each adaptor recess 7 to achieve the desired torsional resistance and resilience. While the rubber torsion ribs 6 and rubber shear rods 18 can be constructed of any selected hardness, a typical hardness for these elements is in the range 80-90 duro rubber. The rubber torsion ribs 6 and shear rods 18 may also be hollow and molded or otherwise constructed with an internal spring or filled with compressed fluid gas such as air, to further vary and control the resistance to shear.

It will be further appreciated by those skilled in the art that the resilience and torsional resistance between the propeller 20 and the propeller drive shaft 24 in a marine outdrive or outboard motor can also be varied by providing a squared-off configuration on the respective longitudinal edges of each torsion rib 6, as illustrated in FIG. 4. In this case, each torsion rib 6 presents a perpendicular anchor in the corresponding adaptor recess 7, to increase the resistance to torsion applied to the driver 8 or directly by the propeller drive shaft 24 to the driver adaptor 2 (FIG. 2A). The torsional resistance can be further modified by tapering the longitudinal edges of the torsion ribs 6 as illustrated in FIGS. 8 and 9 and also, by varying the composition and resiliency of the rib sheaths 28 and the extent of overlap of the diameter or thickness of the torsion ribs 6 and the shear rods or cylinders. For example, the projecting portion of the torsion ribs 6 illustrated in FIGS. 4-5 extend at least halfway above the top edges of the corresponding adaptor recesses 7, and in FIGS. 6 and 7, halfway along the diameter, or coextensive with the radius, of the plastic shear rods 17, the rubber shear rods 18 and the metal shear rods 19, respectively. Accordingly, by adjusting the depth of recessing of the torsion ribs and the shear rods or cylinders in the respective adaptor recesses to a selected degree, a greater or lesser portion of the torsion ribs 6 and/or the shear rods or cylinders is compressed under a torque load. Consequently, the torsional resistance will increase or decrease proportionally between the propeller 20 and the propeller drive shaft 24.

While the preferred embodiments of the invention have been described above, it will be recognized and understood that various modifications may be made in the invention and the appended claims are intended to cover all such modifications which may fall within the spirit and scope of the invention.

1. An exterior shear shoulder assembly for connecting a motor drive shaft to a propeller having a propeller hub, said exterior shear shoulder assembly comprising:
a driver adaptor hub provided in the propeller hub;
at least one torsion member seat provided in said driver adaptor hub;
a driver adaptor engaging the drive shaft in driving relationship; and
at least one torsion member provided on said driver adaptor, said torsion member engaging said torsion member seat for normally preventing rotation of said driver adaptor in said driver adaptor hub responsive to rotation of the propeller, wherein said torsion member may be deformed and sheared responsive to variations in the rotational speed of the propeller and rotation of said driver adaptor in said driver adaptor hub.

2. The exterior shear shoulder assembly of claim 1 comprising a driver receiving the motor drive shaft, said driver engaging said driver adaptor for driving said driver adaptor, said driver adaptor hub and the propeller hub and propeller in concert.

3. The exterior shear shoulder assembly of claim 1 wherein said at least one torsion member seat comprises a plurality of torsion member seats provided in said driver adaptor hub in radially spaced-apart relationship with respect to each other and said at least one torsion member comprises a plurality of torsion members provided on said driver adaptor in radially spaced-apart relationship with respect to each other for engaging said torsion member seats, respectively.

4. The exterior shear shoulder assembly of claim 3 comprising a driver receiving the motor drive shaft, said driver engaging said driver adaptor for driving said driver adaptor, said driver adaptor hub and the propeller hub and propeller in concert.

5. The exterior shear shoulder assembly of claim 1 comprising at least one adaptor recess provided in said driver adaptor for registering with said at least one torsion member seat provided in said driver adaptor hub and wherein said at least one torsion member is recessed in said at least one adaptor recess and engages said at least one torsion member seat.

6. The exterior shear shoulder assembly of claim 5 wherein said at least one adaptor recess comprises a plurality of adaptor recesses provided in said driver adaptor in radially spaced-apart relationship with respect to each other and said at least one torsion member seat comprises a plurality of torsion member seats provided in said driver adaptor hub opposite said adaptor recesses, respectively, and wherein said at least one torsion member comprises a plurality of torsion members seated in said adaptor recesses and engaging said torsion member seats, respectively.

7. The exterior shear shoulder assembly of claim 6 comprising a driver receiving the motor drive shaft, said driver engaging said driver adaptor for driving said driver adaptor, said driver adaptor hub and the propeller hub and propeller in concert.

8. The external shear shoulder assembly of claim 1 comprising air gaps defined between said driver adaptor and said driver adaptor hub adjacent to said torsion member for accommodating a portion of said torsion member responsive to said variations in the rotational speed of the propeller.

9. The exterior shear shoulder assembly of claim 8 comprising at least one adaptor recess provided in said driver adaptor for registering with said at least one torsion member seat provided in said driver adaptor hub and wherein said at least one torsion member is recessed in said at least one adaptor recess and engages said at least one torsion member seat.

10. The exterior shear shoulder assembly of claim 9 wherein said at least one adaptor recess comprises a plurality of adaptor recesses provided in said driver adaptor in radially spaced-apart relationship with respect to each other and said at least one torsion member seat comprises a plurality of torsion member seats provided in said driver adaptor hub opposite said adaptor recesses, respectively, and wherein said at least one torsion member comprises a plurality of torsion members seated in said adaptor recesses and engaging said torsion member seats, respectively.

11. The external shear shoulder assembly of claim 8 comprising a driver receiving the drive shaft, said driver engaging said driver adaptor for driving said driver adaptor, said driver adaptor hub and the propeller hub and propeller in concert.

12. The exterior shear shoulder assembly of claim 10 comprising a driver receiving the motor drive shaft, said driver engaging said driver adaptor for driving said driver adaptor said driver adaptor hub and the propeller hub and propeller in concert.

13. The exterior shear shoulder assembly of claim 10 wherein said torsion members are selected from the group consisting of metal, plastic and rubber.

14. The exterior shear shoulder assembly of claim 1 comprising a resilient member engaging said torsion member for cushioning said torsion member in said torsion member seat.

15. The exterior shear shoulder assembly of claim 14 comprising a driver receiving the motor drive shaft, said driver engaging said driver adaptor for driving said driver adaptor, said driver adaptor hub and the propeller hub and propeller in concert.

16. The exterior shear shoulder assembly of claim 14 comprising at least one adaptor recess provided in said driver adaptor for registering with said at least one torsion member seat provided in said driver adaptor hub and wherein said at least one torsion member is recessed in said at least one adaptor recess and engages said at least one torsion member seat.

17. The exterior shear shoulder assembly of claim 16 wherein said at least one adaptor recess comprises a plurality of adaptor recesses provided in said driver adaptor in radially spaced-apart relationship with respect to each other and said at least one torsion member seat comprises a plurality of torsion member seats provided in said driver adaptor hub opposite said adaptor recesses, respectively, and wherein said at least one torsion member comprises a plurality of torsion members seated in said adaptor recesses and engaging said torsion member seats, respectively.

18. The exterior shear shoulder assembly of claim 14 comprising air gaps defined between said driver adaptor and said driver adaptor hub adjacent to said torsion member for accommodating a portion of said torsion member responsive to said variations in the rotational speed of the propeller.

19. The exterior shear shoulder assembly of claim 18 comprising a driver receiving the motor drive shaft, said driver engaging said driver adaptor for driving said driver adaptor, said driver adaptor hub and the propeller hub and propeller in concert.

20. The exterior shear shoulder assembly of claim 19 comprising at least one adaptor recess provided in said driver adaptor for registering with said at least one torsion member seat provided in said driver adaptor hub and wherein said at least one torsion member is recessed in said at least one adaptor recess and engages said at least one torsion member seat.

21. The exterior shear shoulder assembly of claim 20 wherein said at least one adaptor recess comprises a plurality of adaptor recesses provided in said driver adaptor in radially spaced-apart relationship with respect to each other and said at least one torsion member seat comprises a plurality of torsion member seats provided in said driver adaptor hub opposite said adaptor recesses, respectively, and wherein said at least one torsion member comprises a plurality of torsion members seated in said adaptor recesses and engaging said torsion member seats, respectively.

22. An exterior shear shoulder assembly for connecting a motor drive shaft to a propeller having a propeller hub and a hub interior, said exterior shear shoulder assembly comprising:
a driver adaptor hub provided in said propeller hub and a plurality of torsion seats provided in said driver adaptor hub in spaced-apart relationship with respect to each other;
a driver adaptor extending into said driver adaptor hub for normal rotation with the propeller hub and said driver adaptor hub and a plurality of recesses provided in said driver adaptor, said recess facing said torsion seats in said driver adaptor hub;
a plurality of shear members disposed in said recesses and projecting against said torsion seats, respectively;
a plurality of air gaps disposed between said torsion seats in said driver adaptor hub and said driver adaptor adjacent to said shear members, respectively; and
a plurality of resilient cushioning members provided on said shear members for cushioning said shear members in said torsion seats, respectively, wherein said shear members and said cushioning members are compressed in said torsion seats and said recesses, respectively, responsive to rotation of the propeller on the motor drive shaft and said shear members may extend at least partially into said air gaps and shear responsive to torque loads generated by rotational speed variations of the propeller with respect to the motor drive shaft.

23. The exterior shear shoulder assembly of claim 22 comprising a driver receiving the motor drive shaft, said driver engaging said driver adaptor for driving said driver adaptor, said driver adaptor hub and the propeller hub and propeller in concert.

24. An exterior shear shoulder assembly for connecting a motor drive shaft to a propeller having a propeller hub and a hub interior, said exterior shear shoulder assembly comprising:
a plurality of torsion seats radially disposed in the propeller hub;
a cylindrical driver adaptor removably seated in the hub interior and a plurality of torsion members provided on said driver adaptor, said torsion members engaging said torsion seats and said torsion recesses, respectively; and
resilient torsion member sheaths provided on said tension members, respectively, wherein said torsion member sheaths and said torsion members are at least compressed in said torsion seats and said torsion recesses responsive to rotation of the propeller on the motor drive shaft and said torsion member sheaths and said torsion members are distorted and may be sheared responsive to the torque produced by selected and accidental rotational speed variations in the propeller and rotation of said driver adaptor in said hub interior of the propeller hub.

25. The exterior shear shoulder assembly of claim 18 comprising a driver receiving the motor drive shaft, said driver engaging said driver adaptor for driving said driver adaptor and the propeller hub and propeller in concert.

26. The exterior shear shoulder assembly of claim 19 wherein said torsion members are selected from the group metal, rubber and plastic.
